(19) United States
(12) Patent Application Publication
(10) Pub. No.: US 2025/0367600 A1
(43) Pub. Date: Dec. 4, 2025

(54) Processes to Clean Tail Gas from Carbon Black Production and System and Facility for Same

(71) Applicant: Cabot Corporation, Boston, MA (US)

(72) Inventors: Daxiang Wang, Dracut, MA (US); Wei-Ming Chi, Tomball, TX (US)

(21) Appl. No.: 18/874,132

(22) PCT Filed: Jun. 21, 2023
(86) PCT No.: PCT/US2023/068770

§ 371 Date: Dec. 12, 2024

Related U.S. Application Data
(60) Provisional application No. 63/356,196, filed on Jun. 28, 2022.
(60) Provisional application No. 63/405,006, filed on Sep. 9, 2022.

(51) Int. Cl. B01D 53/86; B01D 53/54; B01D 53/62; C01B 3/12; C01B 17/04; C01B 32/50; C01C 1/02; C10J 3/72; C10K 1/00

(52) U.S. Cl. CPC B01D 53/8609; B01D 53/54; B01D 53/62; C01B 3/12; C01B 17/0404; C01B 17/0495; C01B 32/50; C01C 1/026; C10J 3/721; C10K 1/004; B01D 2257/104; B01D 2257/302; B01D 2257/304; B01D 2257/306; B01D 2257/308; B01D 2257/504; B01D 2258/02

(57) ABSTRACT

A process to clean a gas stream is described. The gas stream can include tail gas generated during carbon black production. The process involves a number of steps to systematically clean the starting gas stream so as to obtain a treat gas stream having fuel value and converting other parts of the gas stream to sulfur and carbon dioxide for recovery. A facility or system having various operation units to conduct the process of the present invention is further described.

### BACKGROUND OF THE INVENTION

The present invention relates to cleaning gas streams, such as industrial gas streams. More specifically, the present invention relates to processes to clean gas streams partly or entirely from carbon black production. The present invention further relates to facilities and/or apparatus set-ups and/or systems to clean such gas streams. The present invention, in addition, relates to processes to remove such components as sulfur and carbon dioxide from the tail gas generated during carbon black production.

There is more and more demand and effort in the cleaning industrial gas streams and this demand exists with carbon black production. Further, with cleaning gas streams, there is further a demand to reuse parts of the gas stream and thus reduce the amount of gas emissions into the environment and to do so in more energy efficient ways.

In typical furnace black production processes, the carbon black yield (defined as fraction of feedstock converted to CB product) ranges from 35 to 65% depending on the feedstock quality and target morphology (Compilation of Air Pollutant Emission Factors. AP-42, Vol. 1, Section 6.1.1.1, U.S. Environmental Protection Agency, Fifth Edition, 1995) and can be even higher depending on the carbon black and process conditions. With the additional carbon from primary burner fuel (natural gas or oil) being converted to CO₂, the overall carbon from fuel and feedstock will end up in the primary byproduct (tail gas) stream. When tail gas is used as fuel for process heaters or processed through a thermal oxidizer to generate heat, the carbon species in tail gas are converted to CO₂, a greenhouse gas. The sulfur species in tail gas are combusted to form SOₓ (e.g., SO₂ and SO₃).

Improvements in manufacturing sustainability require SOₓ emission reduction and CO₂ capture. Typically, SOₓ and carbon dioxide are controlled following combustion of the tail gas. However, it would be desirable to control SOₓ emissions and capture carbon dioxide directly from the tail gas to reduce expenses and to reduce water usage and waste generation connected with these processes.

All of the patents and publications mentioned throughout are incorporated in their entirety by reference herein.

### SUMMARY OF THE PRESENT INVENTION

A feature of the present invention is to provide processes to clean gas streams, such as industrial gas streams, including, but not limited to, gas streams partly or entirely from tail gases generated during carbon black production.

A further feature of the present invention is to provide processes to substantially remove sulfur from the gas stream with close to zero SOₓ emission.

A still further feature of the present invention is to provide processes to substantially capture or remove carbon dioxide from the gas stream and preferably with close to zero carbon dioxide emission.

Also, a feature of the present invention is to provide processes and a facility to clean tail gas where the resulting gas volume is smaller (e.g., 30% to 50% smaller) than if the tail gas had been combusted to produce flue gas, which permits the equipment size to be reduced for such processing.

An additional feature of the present invention is to provide processes and a facility (or system or set-up) to clean tail gas that can permit a reduction in operation cost in comparison to tail gas combustion.

Another feature of the present invention is to provide processes and a facility to clean tail gas that does not add to process water consumption in comparison to processes in which tail gas is combusted and the resulting flue gas is cleaned.

Still another feature of the present invention permits the condensate from the tail gas cooling to be reused in carbon black production, such as a quenching fluid.

To achieve these and other advantages, and in accordance with the purposes of the present invention, as embodied and broadly described herein, the present invention, in part, relates to a process to clean a gas stream, such as from an industrial process. More particularly, the process to clean a gas stream preferably includes tail gas generated during carbon black production. The process includes the steps of compressing the gas stream to obtain a compressed gas stream, and conducting several reactions to the gas stream. These reactions include, but are not limited to, at least one hydrolysis reaction to obtain at least H₂S, conducting at least one hydrogenation reaction to convert at least one of SO₂ and SO₃ to H₂S, and conducting at least one oxygen conversion reaction to remove O₂ from the compressed gas stream, thereby obtaining an O₂-poor gas stream. The at least one oxygen conversion reaction either comprises a further hydrogenation reaction to convert O₂ to H₂O or a reduction reaction to convert carbon monoxide to carbon dioxide or both.

The process further includes conducting at least one water gas shift reaction on the O₂-poor gas stream to obtain at least CO₂ and thereby obtain a conditioned syngas stream. The process also includes removing at least a portion of the H₂S and CO₂ from the conditioned syngas stream to obtain a sour gas stream containing the H₂S and CO₂ and obtain a treated gas stream having fuel value. The process, in addition, includes converting at least a portion of the H₂S in the sour gas stream to elemental sulfur and removing the elemental sulfur and obtain a sulfur removal off gas; and capturing at least a portion of the CO₂ in the sulfur removal off gas.

Prior to conducting said at least one hydrolysis reaction, said at least one hydrogenation reaction, and said at least one water gas shift reaction, the process may further include removing at least a portion of any particulates and any catalyst poisons from said gas stream or said compressed gas stream. Removing of the at least a portion of any particulates and any catalyst poisons from said gas stream or said compressed gas stream may include passing said gas stream or compressed gas stream through at least one filtration bed and through at least one adsorbent. The at least one water gas shift reaction may occur after said at least hydrolysis reaction and after said at least hydrogenation reaction. The gas stream may consist of said tail gas generated during carbon black production, and/or may be from two or more carbon black production units. Alternatively or in addition, the gas stream may further comprise gaseous fuel from non-carbon black production sources. In any of these embodiments, at least 80 vol % of the gas stream may be CO, CO₂, N₂, O₂, H₂, hydrocarbons, and water, and also include trace amounts of sulfur species and nitrogen species, and optionally HCl and PH₃ and optionally particulates. For example, at least 80 vol % of the gas stream may be CO, CO₂, N₂, O₂, H₂, hydrocarbons, and water, and also include trace amounts of sulfur species and nitrogen species, and optionally one or more of HCl, and PH₃ and particulates.

In any of these embodiments, the gas stream may include the following component concentrations:
3-30 vol % CO,
0.5-10 vol % CO₂,
3-50 vol % H₂,
0.01-2 vol % O₂,
0.5-10 vol % hydrocarbons,
1-50 vol % water,
50 ppm-10,000 ppm by vol sulfur species,
50 ppm-20,000 ppm by vol nitrogen species,
0 to 20 ppm by vol HCl,
0 to 10 ppm by vol PH₃, and
0 mg/Nm³ to 80 mg/Nm³ particulates.

Alternatively or in addition, compressing may utilize at least one compressor. In any of these embodiments, the at least one hydrolysis reaction may be achieved by utilizing at least one hydrolysis catalyst, and/or the at least one hydrogenation reaction may be achieved by utilizing at least one hydrogenation catalyst, and/or the at least one gas shift reaction may be achieved by utilizing at least one sulfur-resistant catalyst that converts CO and H₂O to CO₂ and H₂. In any of these embodiments, the at least one gas shift reaction may be performed in the presence of at least one cooling device to control temperature during the gas shift reaction, and/or removing at least a portion of said H₂S and CO₂ from said conditioned syngas stream may be achieved by utilizing an amine scrubber, sour gas absorption with non-amine solvent(s), or pressure swing adsorption, and/or converting of at least a portion of the H₂S in said sour gas stream to elemental sulfur may be achieved by utilizing a liquid phase catalytic oxidation process or gas phase combustion process. The gas phase combustion process may utilize a Claus process that converts H₂S and SO₂ to H₂O and S₂.

In any of these embodiments, the gas stream and/or compressed gas stream may be cooled during and/or immediately after said compressing, and/or removing of the at least a portion of any particulates and any catalyst poisons from said gas stream or said compressed gas stream may provide said gas stream or compressed gas stream having less than 5 ppm by volume HCl and less than 5 ppm by volume PH₃. In any of these embodiments, the process may further comprise conducting at least one reduction reaction to the compressed gas stream or the conditioned syngas stream to convert at least a portion of the nitrogen containing species to N₂.

In any of these embodiments, the at least one hydrolysis reaction may convert sulfur species in the compressed gas stream to H₂S, and said sulfur species may include CS₂, COS, and organic sulfur, and/or further convert HCN to NH₃, and or the at least one hydrogenation reaction may convert SO₂, and SO₃ to H₂S and converts O₂ to either H₂O or CO₂ or both.

The present invention further relates to a facility (or system) to clean a gas stream that includes tail gas generated during carbon black production. The facility includes at least one compressor for compressing the gas stream so as to obtain a compressed gas stream: a first catalytic converter unit comprising one or more fixed bed reactors that are configured for conducting at least one hydrolysis reaction to obtain at least H₂S and conducting at least one hydrogenation reaction to obtain at least H₂S, and conducting at least one oxygen conversion reaction to remove O₂ and obtain an O₂-poor gas stream, and further includes a further catalytic converter unit comprising one or more fixed bed reactors (preferably downstream of the first catalytic converter unit) that are configured for conducting at least one water gas shift reaction on the compressed gas stream to obtain CO₂ and obtain a conditioned syngas stream: a sour gas capturing unit for removing at least a portion of the H₂S and CO₂ from the conditioned syngas stream to obtain a sour gas stream containing the H₂S and CO₂ and obtain a treated gas stream having fuel value: a sulfur conversion unit for converting at least a portion of the H₂S in the sour gas stream to elemental sulfur and removing the elemental sulfur and obtain a sulfur removal off gas; and a CO₂ capturing unit for capturing at least a portion of the CO₂ in the sulfur removal off gas.

The facility can further include a gas conditioning unit for removing particulates and catalyst poisons from the gas stream or the compressed gas stream, and/or the fixed bed reactors can be or comprise at least one hydrogenation catalyst, at least one hydrolysis catalyst, and at least one sulfur-resistant catalyst.

Alternatively or in addition, the facility may be characterized by one or more of the following features: The facility can further include at least one cooling device for controlling temperature of the gas stream passing through the catalytic converter unit or exiting the catalytic converter unit or both. The gas conditioning unit can be or include at least one filtration bed and at least one adsorbent, wherein the at least one filtration bed and the at least one adsorbent are in a same vessel or different vessels. The sour gas capturing unit can be or include an amine scrubber, a sour gas absorption unit with non-amine solvent(s), or a pressure swing adsorption unit. The facility may further include at least one cooling device for controlling temperature of the gas stream exiting the at least one compressor.

It is to be understood that both the foregoing general description and the following detailed description are exemplary and explanatory only and are intended to provide a further explanation of the present invention as claimed.

The accompanying drawings, which are incorporated in and constitute a part of this application, illustrate various features of the present invention and, together with the description, serve to explain the principles of the present invention.

### BRIEF DESCRIPTION OF DRAWINGS

FIG. 1 is a flow diagram of a tail gas clean-up process according to an exemplary embodiment of the present invention.

FIG. 2 is a block diagram of a tail gas clean up system or facility according to an exemplary embodiment of the present invention.

FIGS. 3A and 3B together set forth a further block diagram of a tail gas clean up system or facility according to a further exemplary embodiment of the present invention.

### DETAILED DESCRIPTION OF THE PRESENT INVENTION

The present invention relates to processes and facilities to clean a gas stream, such as an industrial gas stream. The gas stream can include, and preferably includes, tail gas generated during carbon black production.

The general steps or aspects of the process of the present invention are as follows.

In the present invention's process, the process comprises or includes compressing a gas stream (e.g., an industrial gas stream such as a tail gas) to obtain a compressed gas stream.

The process further includes conducting several reactions to the gas stream or compressed gas stream.

The several reactions include, but are not limited to, the following:
conducting at least one hydrolysis reaction to obtain at least H₂S;
conducting at least one hydrogenation reaction to convert at least one of SO₂ and SO₃ (or both) to H₂S; and
conducting at least one oxygen conversion reaction to remove O₂ from the compressed gas stream, thereby obtaining an O₂-poor gas stream, wherein the at least one oxygen conversion reaction comprises, consists of, or includes a further hydrogenation reaction to convert O₂ to H₂O or includes a reaction with carbon monoxide to convert carbon monoxide to carbon dioxide or both of these reactions.

The process then further includes conducting at least one water gas shift reaction on the O₂-poor gas stream to obtain at least CO₂ and thereby obtain a conditioned syngas stream.

The process further includes removing at least a portion of the H₂S and CO₂ from the conditioned syngas stream to obtain a sour gas stream containing the H₂S and CO₂ and obtain a treated gas stream having fuel value or utility as feedstock for chemical production, H₂ production and the like.

The process then includes converting at least a portion of the H₂S in the sour gas stream to elemental sulfur and removing the elemental sulfur and obtain a sulfur removal off gas; and capturing at least a portion of the CO₂ in the sulfur removal off gas.

Further details of the process are described below.

With respect to the gas stream that is processed or cleaned by the present invention, the gas stream, as indicated, can be an industrial gas stream. The industrial gas stream can be or includes a tail gas from one or multiple sources. For instance, the gas stream can include or be entirely or solely from tail gas generated during carbon black production.

The gas stream can include or be entirely or solely from one, two, or more carbon black production units (e.g., two or more carbon black reactors). There is no limit on the number of carbon black production units that can contribute to the gas stream that is processed by the present invention. The carbon black production units can be furnace black production units, plasma black production units, and/or other types of carbon black production units. The carbon black production units can be from units that are making the same, similar, or different grades of carbon black.

As an option, the gas stream that is processed by the present invention can further include gaseous fuel from non-carbon black production sources. For instance, the gas stream can include gas streams or gaseous fuel from one or more of the following sources as an option: biomass, natural gas, liquified petroleum gas (LPG) such as from oil fields, coal gas such as from coking processes, byproduct gas such as from steel furnaces, and/or other sources or similar sources as exemplified here.

As an example, the gas stream (i.e., starting gas stream) can comprise at least 25 vol %, at least 50 vol %, at least 75 vol %, at least 80 vol %, at least 90 vol %, at least 95 vol %, at least 99 vol %, or 100 vol % of a gas stream or tail gas from one or more carbon black production units.

The gas stream that is processed by the present invention can be a gas stream where at least 80 vol % (e.g., at least 85 vol %, at least 90 vol %, at least 95 vol %, at least 99 vol %, such as from 80 vol % to 99 vol % or 85 vol % to 99 vol %) of the gas stream is CO, CO₂, N₂, O₂, H₂, hydrocarbons, and water, and also includes trace amounts of sulfur species and nitrogen species, and optionally HCl and PH₃ and optionally particulates.

The gas stream that is processed by the present invention can be a gas stream where at least 80 vol % (e.g., at least 85 vol %, at least 90 vol %, at least 95 vol %, at least 99 vol %, such as from 80 vol % to 99 vol % or 85 vol % to 99 vol %) of the gas stream is CO, CO₂, N₂, O₂, H₂, hydrocarbons, and water, and also includes trace amounts of sulfur species and nitrogen species, and potentially includes one or more of HCl, PH₃, and particulates.

The particulates (e.g., solid particulates), for instance, can be carbon particulates and/or inorganic particulates of salts, such as metal salts (e.g., salts containing Fe, Si, Al, Ca, Cu, and/or Zn in the form of corresponding carbonates, sulfates, and/or oxides, and/or other types of compounds).

The sulfur species can include, but are not limited to, H₂S, COS, CS₂, SO₂, SO₃, and/or C₄H₄S, and the like.

The nitrogen species can include, but are not limited to, HCN, NH₃, NO, and/or NO₂, and the like.

As a further example, the gas stream can include the following component concentrations:
3-30 vol % or more CO (e.g., from 3 to 25 vol %, from 3 to 20 vol %, from 3 to 15 vol % from 3 to 10 vol %, from 3 to 5 vol %, from 5 to 30 vol %, from 10 to 30 vol %, from 15 to 30 vol %, from 20 to 30 vol %),
0.5-10 vol % or more CO₂ (e.g., from 0.5 to 7 vol %, from 0.5 to 5 vol %, from 0.5 to 2 vol %, from 1 to 10 vol %, from 2 to 10 vol %, from 3 to 10 vol %, from 5 to 10 vol %),
3-50 vol % or more H₂ (from 3 to 45 vol %, from 3 to 40 vol %, from 3 to 35 vol %, from 3 to 30 vol %, from 3 to 25 vol %, from 3 to 20 vol %, from 3 to 15 vol %, from 3 to 10 vol %, from 3 to 5 vol %, from 5 to 50 vol %, from 10 to 50 vol %, from 15 to 50 vol %, from 20 to 50 vol %, from 25 to 50 vol %, from 30 to 50 vol %, from 35 to 50 vol %, from 40 to 50 vol %),
0.01-2 vol % or more O₂ (e.g., from 0.01 to 1.5 vol %, from 0.01 to 1 vol %, from 0.01 to 0.5 vol %, from 0.01 to 0.1 vol %, from 0.01 to 0.05 vol %, from 0.02 to 2 vol %, from 0.05 to 2 vol %, from 0.07 to 2 vol %, from 0.1 to 2 vol %, from 0.5 to 2 vol %, from 0.7 to 2 vol %, from 1 to 2 vol %, from 1.25 to 2 vol %);
0.5-10 vol % or more hydrocarbons (e.g., from 0.5 to 7 vol %, from 0.5 to 5 vol %, from 0.5 to 3 vol %, from 0.5 to 1 vol %, from 0.7 to 10 vol %, from 1 to 10 vol %, from 2 to 10 vol %, from 5 to 10 vol %, from 7 to 10 vol %),
1-50 vol % or more water (e.g., from 1 to 45 vol %, from 1 to 40 vol %, from 1 to 35 vol %, from 1 to 30 vol %, from 1 to 25 vol %, from 1 to 20 vol %, from 1 to 15 vol %, from 1 to 10 vol %, from 1 to 5 vol %, from 2 to 50 vol %, from 5 to 50 vol %, from 10 to 50 vol %, from 15 to 50 vol %, from 20 to 50 vol %, from 25 to 50 vol %, from 30 to 50 vol %, from 35 to 50 vol %, from 40 to 50 vol %),
50 ppm-10.000 ppm or more by volume sulfur species (e.g., from 50 to 7,000 ppm, from 50 to 5,000 ppm, from 50 to 2,500 ppm, from 50 to 2,000 ppm, from 50 to 1,500 ppm, from 50 to 1.000 ppm, from 50 to 750 ppm, from 50 to 500 ppm from 50 to 250 ppm, from 50 to 100 ppm, from 100 to 10,000 ppm, from 200 to 10,000 ppm, from 500 ppm to 10,000 ppm, from 1,000 to 10,000 ppm, from 2,000 to 10,000 ppm, from 3,000 to 10,000 ppm, from 5,000 to 10,000 ppm, from 7,000 to 10,000 ppm),
50 ppm-20,000 ppm or more by volume nitrogen species (e.g., from 50 to 15,000 ppm, from 50 to 12,500 ppm, from 50 to 10,000 ppm, from 50 to 7,000 ppm, from 50 to 5.000 ppm, from 50 to 2,500 ppm, from 50 to 2,000 ppm, from 50 to 1,500 ppm, from 50 to 1.000 ppm, from 50 to 750 ppm, from 50 to 500 ppm from 50 to 250 ppm, from 50 to 100 ppm, from 100 to 20,000 ppm, from 200 to 20,000 ppm, from 500 ppm to 20,000 ppm, from 1,000 to 20,000 ppm, from 2,000 to 20,000 ppm, from 3,000 to 20,000 ppm, from 5,000 to 20,000 ppm, from 7.000 to 20,000 ppm, from 10,000 to 20,000 ppm, from 12.500 to 20,000 ppm, from 15,000 to 20,000 ppm, from 17,500 to 20,000 ppm).
0 to 20 ppm or more by volume HCl (e.g., from 0.1 to 20 ppm, from 0.5 to 20 ppm, from 1 to 20 ppm, from 5 to 20 ppm, from 10 to 20 ppm, from 0.1 to 15 ppm, from 0.1 to 10 ppm, from 0.1 to 5 ppm, from 0.1 to 2.5 ppm),
0 to 10 ppm or more by volume PH₃ (e.g., from 0.1 to 10 ppm, from 0.5 to 10 ppm, from 1 to 10 ppm, from 5 to 10 ppm, from 0.1 to 7 ppm, from 0.1 to 5 ppm, from 0.1 to 2 ppm, from 0.1 to 1 ppm), and
0 mg/Nm³ to 80 mg/Nm³ or more particulates (e.g., from 0.1 to 80 mg/Nm³, from 0.5 to 80 mg/Nm³, from 1 to 80 mg/Nm³, from 5 to 80 mg/Nm³, from 10 to 80 mg/Nm³, from 15 to 80 mg/Nm³, from 20 to 80 mg/Nm³, from 30 to 80 mg/Nm³, from 40 to 80 mg/Nm³, from 50 to 80 mg/Nm³, from 60 to 80 mg/Nm³, from 70 to 80 mg/Nm³, from 0.1 to 75 mg/Nm³, from 0.1 to 70 mg/Nm³, from 0.1 to 60 mg/Nm³, from 0.1 to 50 mg/Nm³, from 0.1 to 40 mg/Nm³, from 0.1 to 30 mg/Nm³, from 0.1 to 20 mg/Nm³, from 0.1 to 10 mg/Nm³, from 0.1 to 5 mg/Nm³).

The gas conditions of the gas stream that is processed are not critical. For any given unit process, if the incoming gas stream does not have the desired temperature or pressure, these are easily adjusted using methods known to those of skill in the art. For example, the gas in the gas stream to be processed can have a temperature from ambient (e.g., 20° C. to 25° C.) to 300° C. or other temperatures. Likewise, the pressure of the gas stream to be processed can be 0 barg to 1 barg or other pressures outside of this range.

Regarding the step in the process of compressing the gas stream, at least one compressor can be utilized to achieve this step. More than one compressor can be used and/or the compressor can have multiple stages (multi-stage compressing).

Gas compression can be achieved with any commercially available compression equipment, such as, but not limited to, a centrifugal compressor, a Roots compressor, a screw compressor, a positive displacement compressor, and the like. The gas compression can be such that the gas is pressurized, such as by a booster fan or compressor.

One purpose of compressing the gas stream is to provide a desired pressure to the gas so as to overcome potential pressure drops in downstream steps of the process.

The compressing of the gas stream results in a compressed gas stream. The compressed gas stream has an elevated pressure above atmospheric or a gas pressure above the starting gas pressure entering the compressor(s). The elevated pressure can be from 0.5 to 100 barg or greater, such as from 0.5 to 50 barg, from 0.5 to 45 barg, from 0.5 to 40 barg, from 0.5 to 35 barg, from 0.5 to 30 barg, from 0.5 to 25 barg, from 0.5 to 20 barg, from 0.5 to 15 barg, from 0.5 to 10 barg, from 0.5 to 5 barg, from 1 to 90 barg, from 5 to 80 barg, from 10 to 70 barg, from 15 to 60 barg, from 20 to 50 barg, from 25 to 50 barg, from 30 to 50 barg, from 35 to 50 barg, from 40 to 50 barg).

As an option, the gas stream entering the compressing step (i.e., the raw gas) can be partially cooled at the inlet of the compressor or cooled in between multi-stage compressors (if used) and/or cooled after the last stage of compression. The compressed gas exiting the one or more compressors can have a temperature, due to cooling, of below 500° C., such as from 100° C. to 500° C. or other temperatures.

As an option, the gas stream or compressed gas stream can be subjected to filtration of particulates that may be present in the gas stream. In this step, the gas stream or compressed gas stream has at least a portion of the particulates present in the gas stream removed, such as by filtration, using, for instance, one or more filtration beds, filter beds or other forms of mechanical filtration mechanisms such as, but not limited to, cartridge filter, bag filter, membrane filter, etc.

Besides removing some or most or all of the particulates (i.e., solid particulates) in the gas stream, at least a portion (some or most or all) of any catalyst poisons that may be present can be captured or removed at this stage of the process (e.g., a catalyst poison capture). Thus, this filtration step can further remove at least a portion (some or most or all) of one or more catalyst poisons. Examples of catalyst poisons that may be present in the gas stream include, but are not limited to HCl and/or PH₃. Generally, the catalyst poisons are present in trace amounts (e.g., in amounts as described earlier).

By conducting such a filtration step and/or catalyst poison capture, which can be collectively referred to as gas conditioning or a gas conditioning unit operation, this can enable a more stable operation of the catalytic processes on the gas stream and/or enable the catalytic process to operate more efficiently and/or extend catalyst service life.

For the filtration of the particulates, one or more filtration beds loaded with filter media (which can be in the form of particulates) can be used. The filter particulate media can have various geometric shapes and sizes (e.g., spherical, extrudate, cylindrical, trilobes, rings, and the like). The removal of some or most or all of the particulates can prevent the plugging of the catalyst bed(s) described and used in downstream steps of the process. Filter particulate media that can be utilized in the one or more filter beds are commercially available, such as ceramic spheres, alumina particles, silica particles, silicon aluminate particles, activated carbon particles, zeolites, and/or refractory type particles etc. Particular examples of filter media can include various alumina types such as γ-Al₂O₃ or α-Al₂O₃ of various pore structures and surface areas.

Different configurations of the filter bed(s) can be utilized. One or more filter beds can be used. If more than one filter bed is used, the filter beds can be used in parallel or sequentially (in series) or one filter bed can be used and then a back-up filter bed can be used when the initial filter bed needs cleaning or regenerating or replacing. Generally, a filter bed is spent once a certain level of pressure increase occurs due to blockage. Those skilled in the art would appreciate when this occurs.

If parallel filtration is utilized where one filter bed is on standby, the filtration can be done with one filter bed until the pressure-drop increases to a target level, and a switch can be made to the standby filter bed to continue filtration of the particulates, and during this switch over, the spent filter media can be cleaned or replaced.

By filtration of the particulates from the gas stream, the gas stream can have particulates levels reduced by at least 10 wt %, for example, at least 20 wt %, at least 30 wt %, at least 40 wt %, at least 50 wt %, at least 60 wt %, at least 70 wt %, at least 80 wt %, at least 90 wt %, at least 95 wt %, such as from 10 to 99 wt %, from 50 to 99 wt % or from 75 to 99 wt %, or from 90 to 99 wt %, based on total weight of particulates existing prior to filtration. The particulate content of the gas stream, after particulate filtration, can be 50 mg/Nm³ or lower, below 40 mg/Nm³, below 30 mg/Nm³, below 20 mg/Nm³, below 10 mg/Nm³, below 5 mg/Nm³, below 1 mg/Nm³, such 0.01 mg/Nm³ to 50 mg/Nm³ or from 0.01 mg/Nm³ to 10 mg/Nm³, or from 0.01 mg/Nm³ to 5 mg/Nm³, or from 0.01 mg/Nm³ to 1 mg/Nm³.

Regarding the capture of catalyst poisons, the catalyst poisons can be at least partially captured with the use of one or more types of adsorbents that can be present in an adsorption vessel or container or bed. The adsorbent can be a multifunctional adsorbent or a mixture of two or more adsorbents (e.g., special adsorbents) that are capable of capturing or trapping or adsorbing or otherwise retaining at least a portion catalyst poisons, which as indicated, are or include HCl and/or PH₃. The level of removal desired is a level that permits the downstream use of catalyst for an acceptable or extend service life.

When multiple adsorbents are used, the adsorbents can be loaded into separate vessels in series, or they can be loaded in the same vessel in layers or loaded together as a mixture of adsorbents.

Any commercially available sorbent or adsorbent with the desired function, described herein, can be used. The sorbents or adsorbents can be porous materials. The adsorbents can be, but are not limited to, alumina, silica, silica aluminate, magnesium oxide(s). The adsorbent or sorbents can be optionally modified with alkaline and/or alkaline earth metal oxides for improved performance. Examples of commercially available materials include calcium oxide modified alumina, magnesium modified alumina, Na₂O/Al₂O₃, K₂O/Al₂O₃, high surface area γ-alumina, etc. Commercially available examples include SHIFTGUARD 200 absorbent from Clariant AG, TK-3000 catalyst/sorbent and HTG-10 absorbent from Topsoe A/S, and ET-17 and EG-2 catalysts/sorbents from Haiso Technology Co.

By capturing of the catalyst poisons, the amount of catalyst poisons, such as HCl and/or PH₃ afterwards can be reduced by at least 50 vol %, at least 60 vol %, at least 70 vol %, at least 80 vol %, at least 90 vol %, at least 95 vol %, such as from 50 to 99 vol % or from 75 to 99 vol %, or from 90 to 99 vol %. The catalyst poison content as defined by HCl and/or PH₃ in the exiting gas stream, after poison capture, can be below 5 ppm for each of HCl and/or PH₃, and more preferably below 1 ppm for each of HCl and/or PH₃.

Preferably, the particulate filtration step if used occurs prior to the capturing of catalyst poisons, for example prior to the gas compression step.

Preferably, the capturing of the catalyst poisons if used occurs after the particulate filtration step if used, for example, prior to the gas compression step.

The step of capturing the catalyst poisons and/or the particulate filtration can be conducted at a temperature of from about 100° C. to about 500° C. Other temperatures outside of this range are possible.

Regarding the step of conducting several reactions to the gas stream or compressed gas stream, preferably this part of the process occurs with the compressed gas stream.

The conducting of the at least one hydrolysis reaction to obtain at least H₂S can be in the form of one reaction or multiple reactions using the same or different catalyst. At least one hydrolysis catalyst can be utilized. In this hydrolysis reaction, at least one or more sulfur species in the gas stream, such as CS₂ and/or COS and/or organic sulfur are converted to H₂S through one or more hydrolysis reactions with water or moisture in the gas stream.

The hydrolysis reaction preferably includes one or both of the following reactions:

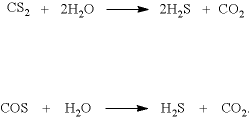

The conducting of the at least one hydrogenation reaction to convert at least one of SO₂ and SO₃ to H₂S can be in the form of one reaction or multiple reactions using the same or different catalyst. At least one hydrogenation catalyst can be utilized. In this hydrogenation reaction, at least one or more sulfur species in the gas stream, such as SO₂ and/or SO₃ are converted to H₂S through one or more hydrogenation reactions with hydrogen in the gas stream.

The hydrogenation reaction preferably includes one or both of the following reactions:

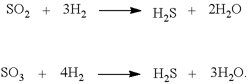

The percent of conversion (from either or both of the hydrolysis and hydrogenation reactions) from the sulfur species to H₂S is preferably at least 50% or at least 60%, or at least 70% or at least 80%, or at least 90% based on starting ppm levels of the sulfur species. The percent of conversion can be from 50% to 99% or more based on starting ppm levels of the sulfur species.

The conducting of the at least one hydrolysis reaction can further include a reaction to convert HCN to NH₃. The at least one hydrolysis catalyst as identified earlier or an additional hydrolysis catalyst can be utilized for this particular reaction. In this additional hydrolysis reaction, HCN in the gas stream (e.g., at least a portion thereof) is converted to NH₃ with water in the gas stream.

The percent of conversion from HCN to NH₃ is preferably at least 50% or at least 60%, or at least 70% or at least 80%, or at least 90% based on starting ppm levels of the HCN. The percent of conversion can be from 50% to 99% or more based on starting ppm levels of the HCN.

The additional hydrolysis reaction preferably includes the following reaction:

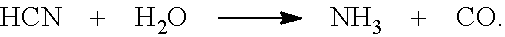

This part of the process can further include conducting at least one reduction reaction on the compressed gas stream or the conditioned syngas stream to convert at least a portion of the nitrogen containing species to N₂. In this part of the process, NO and/or NOx in the gas stream (or at least a portion thereof) can be converted to nitrogen gas (N₂) through a reduction reaction(s). A reduction reaction catalyst(s) can be used for this reaction.

With the reduction reaction, at least 50 vol %, at least 60 vol %, at least 70 vol %, at least 80 vol %, at least 90 vol %, at least 95 vol % (such as from 50 vol % to 99 vol % or higher, or 60 vol % to 99 vol %, or 70 vol % to 99 vol %, or 80 vol % to 99 vol %, 90 vol % to 99 vol %, 95 vol % to 99 vol %) of the NO and/or NOx present in the gas stream just prior to this reaction can be converted to N₂.

The conducting at least one oxygen conversion reaction to remove O₂ from the compressed gas stream can be in the form of one reaction or multiple reactions using the same or different catalyst. At least oxygen converting catalyst can be utilized. In this oxygen conversion reaction, the oxygen conversion reaction comprises, consists of, or includes a further hydrogenation reaction to convert O₂ to H₂O with hydrogen in the gas stream, or includes a reduction reaction to convert carbon monoxide to carbon dioxide with oxygen gas in the gas stream, or both of these reactions. In the reduction reaction, this can be considered a reaction to convert O₂ to carbon dioxide with CO in the gas stream. Thus, in each of the possible reactions, oxygen is being converted to either H₂O or carbon dioxide or both.

The percent of conversion from oxygen gas to either H₂O or carbon dioxide or both is preferably at least 50% or at least 60%, or at least 70% or at least 80%, or at least 90% based on starting volume % levels of the oxygen gas. The percent of conversion can be from 50% to 99% or more based on starting volume % levels of the oxygen gas.

The oxygen converting reaction preferably includes one or both of the following reactions:

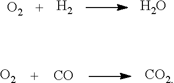

As a result of the oxygen converting reactions, an O₂-poor gas stream is obtained.

With respect to the at least one hydrolysis reaction, the at least one hydrogenation reaction, and the oxygen converting reaction, and optionally the reduction reaction, any commercially available catalyst(s) possessing the described functionality can be used. A combination of catalyst can be used. Examples of catalysts that can be used, include, but are not limited to ACTISORB 405, ACTISORB 410, and ACTISORB O catalysts/sorbents from Clariant AG, DL-1 catalyst from Haiso Technology Co., and CKA-3 and TK-240 catalysts from Topsoe A/S.

The desired reaction temperature for these reactions can be from about 150° C. to about 350° C. or other temperatures outside of this range. If the gas stream from upstream is at a temperature outside of the desired range, a heat exchanger (i.e., heater) or other means to achieve this desired temperature range can be utilized prior to conducting these reactions.

The reactions can be conducted or achieved with a reactor or reactor vessel (or multiple reactor vessels) which can contain the catalyst or combination of catalyst. When more than one reactor or reactor vessel is used, the arrangement of the reactors can be in parallel to reduce the overall pressure drop, which can achieve optimized performance of the reactor. The reactor(s) can be fixed bed reactors that house or contain the one or more mentioned catalyst.

In the alternative, the reactors, when more than one is used, and each have a different catalyst for a different reaction, can be arranged in series.

Any configuration of reactors (e.g., fixed bed reactors) known to those skilled in the art can be utilized. The configuration can be an up-flow, or down-flow, axial flow, radial flow, or horizontal flow.

After the O₂-poor gas stream is obtained, the step of conducting at least one water gas shift reaction on the O₂-poor gas stream to obtain at least CO₂ is conducted to thereby obtain a conditioned syngas stream.

The process of the present invention further includes conducting at least one water gas shift reaction on the O₂-poor gas stream to obtain at least CO₂ and thereby obtain a conditioned syngas stream. Regarding this reaction, this reaction can be considered a CO-water gas shift reaction (WGSR). The reaction can be one or more reactions.

The water gas shift reaction preferably occurs after the aforementioned hydrolysis reaction(s) and after the aforementioned hydrogenation reaction(s) and aforementioned oxygen conversion reaction.

One or more of the hydrolysis and hydrogenation reactions can optionally continue during the water gas shift reaction, if it has not been completed prior to the water gas shift reaction occurring.

The function of the water gas shift reaction is to convert carbon monoxide in the gas stream (at least a portion thereof) to carbon dioxide through reaction with water in the gas stream so as to produce hydrogen gas (H₂).

The water gas shift reaction preferably includes the following reaction:

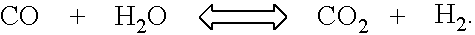

Since the gas stream, at this stage, contains sulfur in the form of H₂S and/or other unconverted sulfur species, the catalyst utilized for this reaction needs to be tolerant to sulfur poisoning (i.e., a sulfur-resistant catalyst). Thus, the water gas shift reaction is achieved by utilizing at least one sulfur-resistant catalyst that converts CO and H₂O to CO₂ and H₂.

Sulfur-resistant WGSR catalysts are commercially available. Suitable examples include, but are not limited to, SSK-10 and SSK-20 catalysts from Topsoe A/S, B303Q-S catalyst from Haiso Technology Co., and KATALCO KB-11 and KATALCO K8-11 HA from Johnson Matthey.

The WSGR catalyst can be formed of a metal sulfide of cobalt, iron, molybdenum, and/or nickel. The WSGR catalyst can be loaded on porous supports, such alumina, silica, or similar support materials. The WSGR catalyst can be in the form of extrudates, pellet, spheres, rings, and/or any other shapes to promote mass transfer and/or minimize pressure drop.

The WSGR catalyst can be pre-sulfurized before loading or obtained in the oxide form and sulfurized in place after loaded into the reactor. To enable the on-site sulfurization, an auxiliary system can be used to supply the reagents (such as CS₂, COS, etc.) and heat to enable proper sulfurization before introduction of the gas stream. Catalyst suppliers generally provide detailed procedures for such an on-site sulfurization process.

The water gas shift reaction is generally an exothermic reaction. The heat of reaction can increase the gas stream temperature in the reactor or reactor beds. Further, the water gas shift reaction is reversible and its conversion can be equilibrium limited if desired. As higher temperatures are not favorable for achieving desired high CO conversion, an option is to use temperature control such as with one or more cooling techniques/devices so as to maximize overall CO conversion. Accordingly, as one option, this part of the process where at least one gas shift reaction is performed is preferably done in the presence of at least one cooling device to control temperature during the gas shift reaction.

For instance, the cooling process can be achieved by installing internal cooling tubes inside the reactor used for the WGSR. An option is to install multiple WGSR reactors in series with interstage heat exchanger to remove heat from the intermediate product streams, or any other heat removal mechanism known in the industry.

The overall conversion of CO in the gas stream as a result of the WSGR can be at least 80 vol %, at least 85 vol %, at least 90 vol %, at least 95 vol %, at least 96 vol %, at least 97 vol %, at least 98 vol %, such as from 80 vol % to 99 vol % or higher, or from 85 vol % to 99 vol %, or from 90 vol % to 95 vol %, or from 95 vol % to 98 vol %, based on vol % of CO in the gas stream at this stage and the remaining amount of CO by vol % present after the WSGR.

Depending on the desired target of the overall carbon capture efficiency, the WGSR part of the process or the WGSR system can be designed for the desired conversion.

Due to the nature of the exothermic reaction, the WSGR and the WGSR reactors are generally not operated isothermally. Instead, the WSGR and the WGSR reactors can generally operate a range of temperature, such as from about 180° C. to about 400° C. The exact temperature profile can depend on the selected catalyst, and/or the desired overall CO conversion and/or the choice of cooling mechanism.

To optimize the WGSR process performance, the water concentration in the gas stream may be adjusted. This can be achieved using standard techniques used in the industry, such as by passing the gas stream through a water column, and/or injection of steam to the gas stream, and/or spraying water into the gas stream or any combinations thereof.

After the WGSR part of the process, the gas stream, which can be considered a conditioned syngas stream, generally contains mainly H₂, CO₂, N₂, H₂S, NH₃, H₂O and amounts (e.g., small amounts) of any other unconverted components carried in with the raw gas stream, such as sulfur compounds, CO, and/or N species. The H₂, CO₂, N₂, H₂S, NH₃, H₂O combined comprise over 50 vol %, over 60 vol %, over 70 vol %, over 80 vol %, over 90 vol %, over 95 vol % (e.g., from 50 vol % to 99 vol % or 75% vol to 99 vol %) of the conditioned syngas stream.

The next step can then be removing at least a portion of the H₂S and CO₂ from the conditioned syngas stream to obtain a sour gas stream containing H₂S and CO₂ and also obtain a treated gas stream having fuel value.

This step can in part be referred to as sour gas capturing and can be achieved with a sour gas capturing unit.

The sour gas capturing separates CO₂ and H₂S out from the gas stream (i.e., the conditioned syngas stream) to produce a sour gas stream containing CO₂, H₂S and some moisture. The rest of the gas components, not separated out, can be considered a treated gas stream having fuel value. This treated gas stream can be sent to a combustor for heat recovery, or processed with other widely known technology such membrane, pressure swing adsorption (PSA), and the like to produce a marketable pure hydrogen product (e.g., hydrogen gas having a purity of at least 95 vol % or at least 99 vol %), or employed in any other process that can derive value from or add value to the treated gas stream.

Separation of CO₂ and H₂S from the gas stream (i.e., the conditioned syngas stream) can be done with many commercially available technologies.

Examples of such technologies include, but are not limited to: amine scrubbing technology, methanol absorption, glycol absorption, and pressure swing adsorption for sour gas capture.

Regarding amine scrubbing technology, in this process, a gas stream, conditioned to a desired temperature (e.g., 30-60° C.) and pressure (e.g., sufficient to overcome the absorber pressure drop and up to 100 barg), is brought in contact with an amine solution in a column. Various types of contacting columns can be used, such as a tray column, random packed column, structured packing or any combination of these. CO₂ and H₂S (or at least a portion thereof) are absorbed onto the amine compound(s) and the other components in the gas stream pass through this column as a product stream. The amine solution with absorbed H₂S and CO₂ can be transferred to another column, where heat can be added to promote the desorption of H₂S and CO₂ from the amine solution. A regenerated amine stream, after temperature adjustment (e.g., 30-60° C.), is circulated back to the absorption column for further H₂S and CO₂ absorption. The heat input can depend on the type of sorbent and design conditions utilized, but can be typically from about 2 to about 5 MJ/kg-of-CO₂-captured. The H₂S and CO₂ released from the desorption process produces a sour gas stream that can be processed in the next unit operation.

Solvents that can be used in this process include primary amines (e.g., monoethanolamine (MEA), diglycolamine (DGA)), secondary amines (e.g., diethanolamine (DEA) and diisopropylamine (DIPA)), and/or tertiary amines (e.g., methyl diethanolamine (MDEA)). The sorbent can be an aqueous solution having a concentration (e.g., 5-50 wt %) of one or more amines. One or more additives having different functions can be additionally used and, for instance, can be blended in with the sorbent to improve corrosivity and/or absorption efficiency and/or to achieve one or more other performances.

A conditioning step for the gas stream (i.e., the conditioned syngas stream) can be conducted, for instance, where, prior to entering the absorption unit for sour gas capturing, the gas stream is cooled and as a result, condensate may form as the gas stream is cooled below its dew point. This water condensate stream can be used in carbon black production as quenching water and/or other process water uses.

Another process that can be used for the sour gas capturing is one or more absorptions with the use of one or more solvents, such as methanol or a glycol or alkaline salt solution. This process is very similar to the amine absorption process. Commercially available sour gas absorption units/techniques can be adopted for this part of the process of the present invention. Commercially available units include those from Shell, Mitsubishi Heavy Industries, Honeywell/UOP, Linde, Technip, and many other technology suppliers, and engineering EPC (engineering, procurement, and construction) firms.

Another process/technique that can used for sour gas capturing includes pressure swing adsorption (PSA). For this PSA, a solid adsorbent(s) can be used to capture H₂S and CO₂ at elevated pressures (e.g., a pressure of 2 barg to 100 barg), and then the solid adsorbent can be desorbed using reduced pressures (e.g., atmospheric pressure to 100 barg) to obtain a concentrated H₂S and CO₂ stream and also obtain a clean gas stream with low amounts of H₂S and CO₂. For example, the clean gas stream may include the treated gas and may contain up to 20 ppmv H₂S, for example, up to 10 ppmv, up to 5 ppmv, or up to 1 ppmv H₂S, or less. Alternatively or in addition, it can contain up to 5 vol % CO₂, for example, up to 2 vol %, up to 1 vol %, up to 0.5 vol %, or up to 0.1 vol % CO₂ or less. As indicated, the concentrated H₂S and CO₂ stream can be considered the sour gas stream, and the clean gas stream can be considered the treated gas stream having fuel value. The heating value of the treated gas can depend on the raw gas composition. For the clean gas stream, the treated gas heating value can be from about 2 to about 6 MJ/Nm³ or other values below or above this range. If other gas sources (such as biomass syngas, coke oven gas) are blended into the starting feed, the heating value range can be above or below this range.

Since the clean gas stream can still contain NOx-forming components (e.g., ammonia), NOx removal technology or steps can optionally be implemented if the clean gas stream is burned for any reason to generate a flue gas. Exemplary NOx removal processes include, but are not limited to, injection of ammonia or urea into a flue gas stream and selective catalytic reactor (SCR) processes known to those of skill in the art, including but not limited to methods described in U.S. Pat. No. 9,192,891, the entire contents of which are incorporated herein by reference. Alternatively to or in addition, a selective non-catalytic reactor (SNCR) process including, but not limited to, methods described in the '891 patent may be used to remove NOx from a flue gas. Because SCR and SNCR processes operate most efficiently in particular temperature ranges (typically 275-500° C. and 900-1050° C., respectively), those of skill in the art may adjust the temperature of a flue gas using boilers, heat exchangers, and other conventional apparatus to allow the selected process(es) to operate more effectively. Alternatively or in addition, a catalytic process such as that described in EP2561921, the contents of which are incorporated herein by reference, or commercially available processes such as the SNOX™ process from Haldor Topsoe may also be employed. Alternative methods known to those of skill in the art may also be employed.

Once the sour gas stream is obtained, the next step in the process can be to convert at least a portion of the H₂S in the sour gas stream to elemental sulfur and then remove the elemental sulfur so as to obtain a sulfur removal off gas.

Various commercially available technologies can be used for this converting to sulfur step, such as, but not limited to, liquid phase catalytic oxidation technology or gas phase combustion technology, and the like. The gas phase combustion process can utilize a Claus process, for example, as described in U.S. Pat. No. 3,719,744, incorporated in its entirety by reference herein, that converts H₂S and SO₂ to H₂O and S₂.

The relatively low concentration of H₂S in the sour gas stream can be more adequately processed with liquid phase oxidation technology than with other processes, e.g., a Claus process. In a liquid phase oxidation process, a gas mixture of CO₂, H₂S and H₂O is brought in contact with an aqueous solution of iron catalyst in a reactor column. The H₂S is oxidized to elemental sulfur by reacting with Fe(III) to form Fe(II). The reaction product stream is transferred to a regeneration reactor, where ambient air bubbles through the liquid to oxidize Fe(II) back to Fe(III) to regenerate the catalyst. The regenerated catalytic liquid is circulated back to the oxidation reactor column to promote H₂S oxidation. Elemental sulfur produced in this oxidation process forms crystalline sulfur suspended in the aqueous liquid solution. A slip stream of this solution is sent to a liquid-solid separator, such as a belt filter, press and frame filter or any other type of separator to produce a solid sulfur product which is marketable (or useable material).

CO₂ is inert in this oxidation reactor column, and the CO₂ passes through the reactor unconverted to form a high concentration, pure CO₂ stream with a certain amount of moisture. This CO₂ stream can be further processed through a unit operation (e.g., an operation that provides compression, drying, and/or cryogenic liquification) to produce supercritical CO₂, liquid CO₂ and/or compressed CO₂. This CO₂ can be easily utilized for enhanced oil recovery (EOR) or other applications, or the CO₂ can be sequestrated or collected in proper storage units.

Alternatively or in addition, sour gas may be captured by separating H₂S and CO₂ from the conditioned gas in two separate steps. Each of the process technologies described above can be used to separately capture H₂S and CO₂ with some adjustment of the sorbent property and/or design operation conditions which is easily made by one of skill in the art. The H₂S-rich stream can be oxidized to elemental sulfur using the catalytic process described above, or it can be oxidized to elemental sulfur using a Claus process.

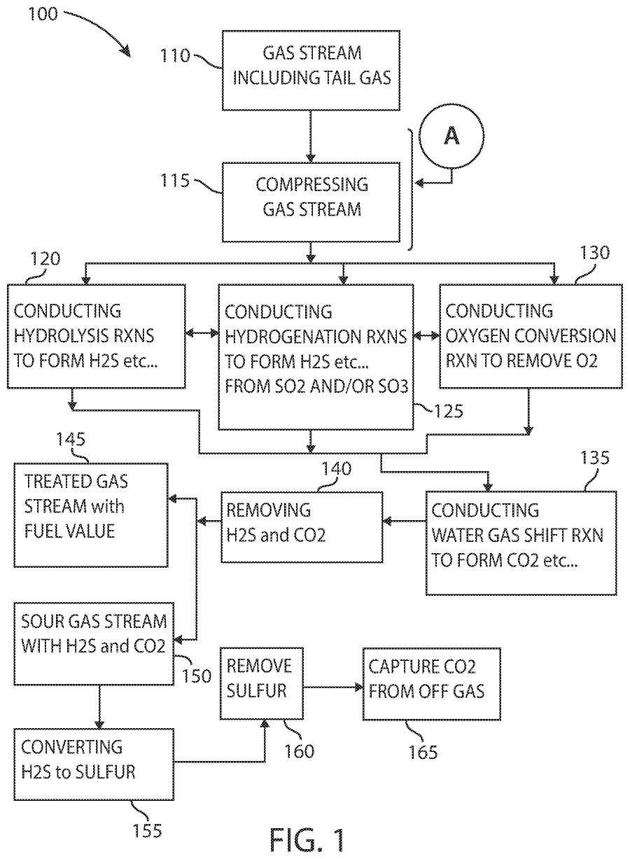

FIG. 1 sets forth a flow diagram of a process 100 of the present invention that can be utilized. In step 110, a gas stream that includes tail gas, such as tail gas generated during carbon black production or manufacturing is obtained.

In optional step A, the gas stream can have at least some of the particulates and/or catalyst poisons removed from the gas stream. This can occur before and/or after the step 115 of compressing the gas stream that forms a compressed gas stream.

In step 120, the compressed gas stream is subjected to at least one hydrolysis reaction so as to form at least H₂S and convert HCN, if present, to NH₃.

In step 125, the compressed gas stream is subjected to at least one hydrogenation reaction to form at least H₂S from at least SO₂ and/or SO₃.

In step 130, the compressed gas stream is subjected to at least one oxygen conversion reaction to remove oxygen (O₂). This reaction can be a further hydrogenation reaction to convert O₂ to H₂O and/or a reduction reaction to convert CO to CO₂.

Steps 120, 125, and 130 can occur in any order. Preferably, step 130 is performed after steps 120 and 125 to obtain a O₂-poor gas stream.

In step 135, the gas from step 130 (preferably) or step 120 or 125 is subjected to at least one water gas shift reaction to form at least CO₂. This forms a conditioned syngas stream.

In step 140, the conditioned syngas stream is subjected to a process to remove at least a portion of the H₂S and CO₂ and form two gas streams, where in step 145, a treated gas stream with fuel value is recovered/obtained and in step 150, a sour gas stream containing H₂S and CO₂ is obtained or recovered or separated from the treated gas stream.

In step 155, at least a portion of the H₂S in the sour gas stream is converted to at elemental sulfur and in step 160, can be recovered or removed or separated from the rest of this gas stream.

In step 165, the rest of the gas stream (the sulfur removal off gas) can be subjected to a process to capture at least a portion of the CO₂.

The above process to clean the gas stream can be achieved in a facility or system that is set up to conduct the various steps described herein. Thus, the present invention further relates to a system and/or facility to clean a gas stream that includes tail gas generated during carbon black production.

The facility includes at least compressor unit or at least one compressor for compressing the gas stream so as to obtain a compressed gas stream.

The facility further includes a catalytic converter unit comprising one or more fixed bed reactors that are configured for conducting the above mentioned at least one hydrolysis reaction to obtain at least H₂S and conducting at least one hydrogenation reaction to obtain at least H₂S, and conducting at least one oxygen conversion reaction to remove O₂ from the gas stream or compressed gas stream.

The facility further includes a WGSR reactor bed for conducting at least one water gas shift reaction on the compressed gas stream to obtain CO₂ and obtain a conditioned syngas stream. This part of the facility can optionally include one or more cooling devices or means to control the temperature of the gas before and/or after and/or during its residence time in the WGSR reactor bed. This part of the facility can optionally include a water input device to introduce water or moisture into the gas stream before or during its residence time in the WGSR reactor.

The facility also includes a sour gas capturing unit for removing at least a portion of the H₂S and CO₂ from the conditioned syngas stream to obtain a sour gas stream containing the H₂S and CO₂ and obtain a treated gas stream having fuel value.

The facility also includes a sulfur conversion unit for converting at least a portion of the H₂S in the sour gas stream to elemental sulfur and removing the elemental sulfur and obtain a sulfur removal off gas.

The facility further includes a CO₂ capturing unit for capturing at least a portion of the CO₂ in the sulfur removal off gas.

The facility can further include a gas conditioning unit for removing particulates and/or catalyst poisons from the gas stream or the compressed gas stream as described herein.

The gas conditioning unit of the facility can be or include at least one filtration bed and at least one adsorbent, wherein the at least one filtration bed and the at least one adsorbent are in a same vessel or are in different vessels.

The one or more fixed bed reactors can include or comprise at least one hydrogenation catalyst, at least one hydrolysis catalyst, and at least one sulfur-resistant catalyst.

The facility can further include or comprise at least one cooling device for controlling temperature of the gas stream passing through the catalytic converter unit or exiting the catalytic converter unit or both.

The sour gas capturing unit can be or include an amine scrubber, a sour gas absorption unit with non-amine solvent(s), or a pressure swing adsorption unit or any combinations thereof.

The facility can further include at least one cooling device(s) for controlling temperature of the gas stream exiting the at least one compressor, as described herein.

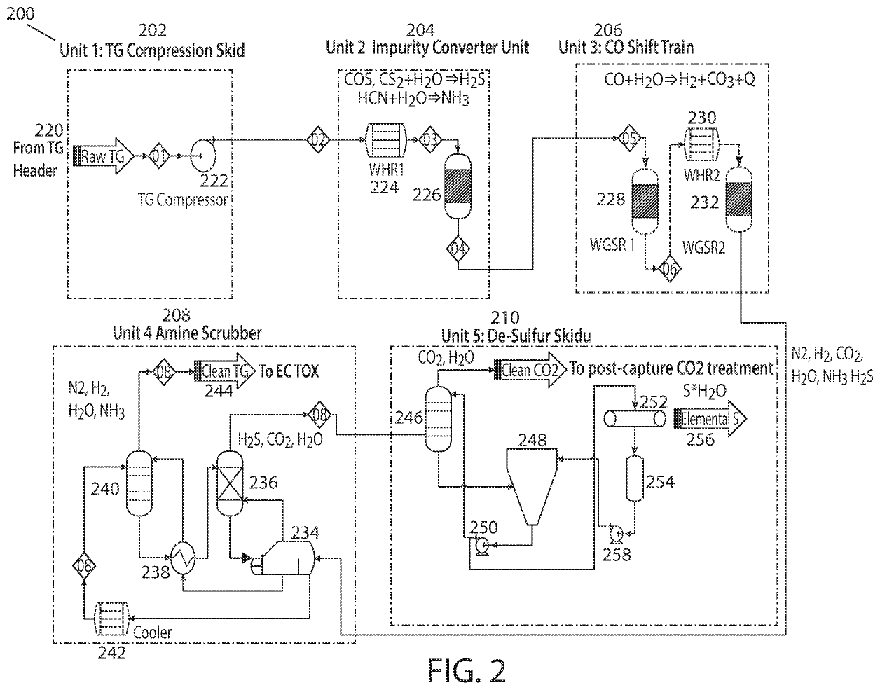

Referring to FIG. 2, in a schematic presentation, one possible set up for a facility or system to conduct the process of the present invention is exemplified. Variations of this facility can be employed as described herein.

In FIG. 2, five unit operations are provided for the facility or system 200. A first unit operation 202 that is gas stream or tail gas compression is provided. A gas stream 220 that can include raw tail gas that is separated from carbon black after leaving a carbon black furnace can be obtained and fed to the first unit operation 202. This gas stream is fed into a device 222 to compress the gas stream and/or pressurize the gas stream. For instance, a tail gas heater can be used that is pressurized, e.g., with a booster fan, to a desired pressure to either just enough to overcome the pressure drop of the downstream processes or to higher pressure for better efficiency.

Installation of a device(s) (not shown in FIG. 2) to remove particulates and/or catalyst poisons from the gas stream can be used in the facility. For instance, a filtration column or other device, upstream or downstream of the device 222 used to compress the gas stream (e.g., booster fan), can be packed with solid particulates in various shapes and/or sizes can be used and is optional. The part of facility or system is optionally used for trapping the particulates, such as carbon black particulates and/or other particulates to prevent or reduce the risk of downstream plugging of other units, such as the one or more catalytic reactors.

Depending on the gas purity, a guard bed or other device (not shown in FIG. 2) can be installed downstream of the unit to compress the gas stream (e.g., booster fan) to remove catalyst poisons such as hydrogen chloride, phosphorous hydride etc.

In a second unit operation 204, the compressed gas stream or tail gas is conditioned to achieve hydrolysis and hydrogenation (e.g., as shown in the equations below) using a multifunctional catalyst or a combination of catalysts with desired functionalities. In this second unit operation 204, devices (e.g., 224 and 226) are used to achieve at least one hydrolysis reaction, at least one hydrogenation reaction and to conduct at least one oxygen conversion reaction. The following one or more reactions can take place in the second unit operation in one or multiple devices that can be arranged in series to each other.

### Hydrolysis:

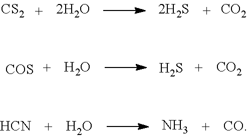

### Hydrogenation:

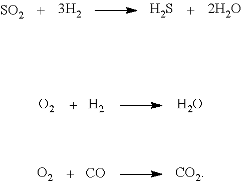

In a third unit operation 206, one or more devices 228, 232 (e.g., catalyst reactors) promote a water gas shift reaction (WGSR) such as a CO WGSR so as to convert CO to CO₂ via reaction with H₂O. This third unit operation may include a multistage reactor series with intermittent heat removal 230 to achieve the desired performance.

### Water Gas Shift Reaction:

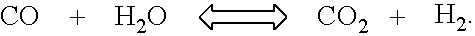

The water gas shift reaction is optional until carbon dioxide capture is needed. In preferred embodiments, at least 99.9% (by vol) of sulfur is converted to hydrogen sulfide, at least 99.9% (by vol) of hydrogen cyanide is converted to ammonia, and the resulting gas has at most 0.1 vol % oxygen and at most 0.5 vol % carbon monoxide.

In a fourth unit operation 208, carbon dioxide and hydrogen sulfide are captured via an amine scrubbing system from the off gas from the third unit operation 206 to produce a treated gas stream having high fuel value, such as a high hydrogen content fuel with a high heating value. The gas leaving unit operation 206 transfers heat to an amine solution in boiler 234 and is directed to cooler 242. The cooled gas is directed to column 240 where it contacts the amine solution which adsorbs carbon dioxide and hydrogen sulfide. The cleaned tail gas 244 has high energy value and can be directed to a variety of beneficial uses. The dirty amine solution leaves column 240 and is heated in heat exchanger 238 before being directed to regeneration column 236, where hydrogen sulfide and carbon dioxide are desorbed from the amine solution to form a gas that is directed to unit operation 210. The regenerated amine solution is passed through boiler 234 and reheated. Any further carbon dioxide, hydrogen sulfide, and water vapor generated is returned to regeneration column 236 and eventually directed to unit operation 210, while the regenerated amine solution is cooled in heat exchanger 238 and optional further heat exchangers before being redirected to column 240. In preferred embodiments, the removal efficiency of hydrogen sulfide is at least 99% (by vol) or the concentration of hydrogen sulfide in the treated gas is, for instance, at most 1 ppm. In preferred embodiments, less than 5% (by vol) of the carbon dioxide present after the third unit operation is removed during the fourth unit operation.

In a fifth unit operation 210, a gas containing hydrogen sulfide is removed from the conditioned gas stream, concentrated, and converted to elemental sulfur through one or processes, such as the liquid phase process described above, which can utilize oxidation reactor 246, catalyst regenerator 248, and liquid-solid separator 252 to remove sulfur 256 from gas stream 9. Buffer tank 254 and pumps 258 and 250 move the liquid catalyst through the various apparatus of unit operation 210. In preferred embodiments, elemental sulfur generated in the fifth unit operation has a purity of at least 99% (by weight).

H₂S and CO₂ can be captured through a single unit operation of sour gas absorption from the product tailgas stream exiting the WGSR. The sour gas stream can be processed in the next unit operation to oxidize H₂S to elemental sulfur as a marketable product. This oxidation step captures sulfur from the sour gas stream and produces a clean moisture-containing CO₂ stream that can be easily sequestered or used for enhanced oil recovery.

The tail gas volume flow is significantly smaller than the flow of the combusted flue gas or starting gas stream. Therefore, a reduced amount of equipment is required to process the tail gas. Likewise, a reduced amount of sorbent is required, further reducing the resulting amount of solid pollutant. Cooling the tail gas produces condensate that can be used in other unit processes in the carbon black production process.

### Examples

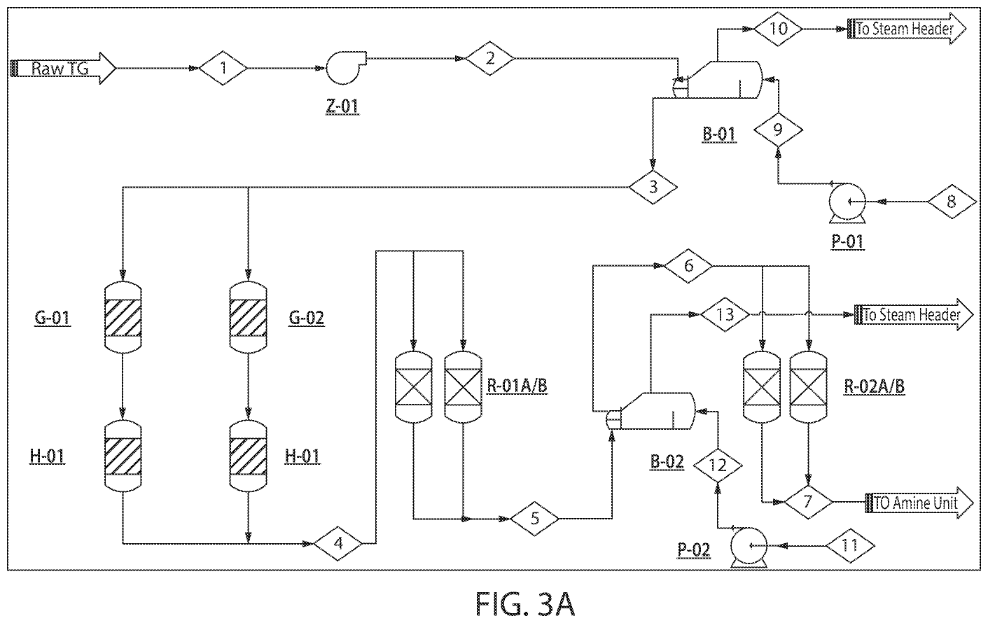

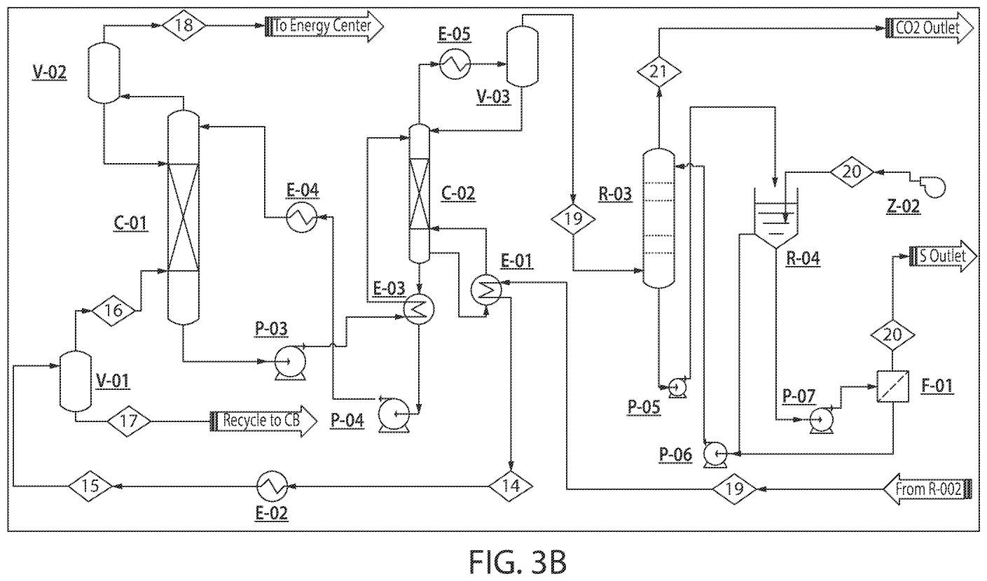

To quantitatively demonstrate the process of the present invention, a simulation was conducted using Aspen simulation and based on aggregated tail gas data from carbon black production facilities. In the simulation, the operation unit set up as shown in FIGS. 3A and 3B was used. The operation set up/flow chart continues from FIG. 3A to FIG. 3B where “TO Amine Unit” in FIG. 3A continues in FIG. 3B at the “From R-002” arrow.

In FIGS. 3A-B, the abbreviations/symbols are as follows:
Z-01-Tail Gas Compressor
G-01/G-02-Guard Beds
B-01/B-02-Waste Heat Boiler
P-01/P-02-Boiler Feed Water pumps
H-01/H-02-Hydrolysis Reactor(s)
R-01A/B-1st Stage Water Gas Shift Reactor
R-02A/B-2nd Stage Water Gas Shift Reactor
E-01-Reboiler
E-02-Chiller
V-01/V-02/V-03: Gas-Liquid Separator
C-01-Absorber
C-02-Regenerator
P03/P04-Sorbent pumps
E03/E04/E05-Heat Exchanger
R-03-H₂S-Oxidation Reactor
R-04-Catalyst Regenerator
P05/P06-Slurry Pumps
P-07-Bleed pump
Z-02-Air blower
F-01-Sulfur Filter.

The following operation units were used/simulated:
First Operation Unit: Gas compression (Z-01)
Second Operation Unit: Gas conditioning (G-01, G-02, B-01, B-02, P-01, P-02, H-01, H-02)
Third Operation Unit: CO shift unit (R-01, R-02)
Fourth Operation Unit: Amine sour gas scrubber (E-01, E-02, V-01/02/03, C01, C02, P03 and P04, E03/04/05)
Final Operation Unit: De-sulfurization unit (R03, R04, P05/06, P07, Z02, F01)

In this simulation, the Tables below, set forth the results for the gas stream as the gas stream progresses through the operation units of FIGS. 3A-B. The ‘stream number’ in the Tables represent the stream location shown in FIGS. 3A-B.

TABLE 1A

| | | Stream Number | | | | | | |
|---|---|---|---|---|---|---|---|---|
| | Unit | 01 | 02 | 03 | 04 | 05 | 06 | 07 |
| Description | | Raw TG | Compressed | Guard/ | WGS1 | WGS1 | WGS2 | WGS2 |
| | | | TG | Hydrolyzer | inlet | Outlet | inlet | outlet |
| | | | | Inlet | | | | |
| Flow | kmol/h | 5,533 | 5,533 | 5,533 | 5,532 | 5,532 | 5,532 | 5,532 |
| Flow | Nm3/h | 124,000 | 124,000 | 124,000 | 123,979 | 123,979 | 123,979 | 123,979 |
| Flow | ac m3/h | 235,174 | 568,912 | 426,776 | 424,968 | 364,464 | 295,297 | 277,071 |
| Flow | kg/h | 113,412 | 113,412 | 113,412 | 113,412 | 113,412 | 113,412 | 113,412 |
| Temperature | deg. C. | 230 | 357.6 | 200 | 202.8 | 310.8 | 200 | 205 |
| pressure | bara | 1.04 | 2.01 | 2.01 | 1.69 | 1.53 | 1.53 | 1.46 |
| Composition | | | | | | | | |
| H2S | ppmvw | 1218 | 1218 | 1218 | 2981 | 2981 | 2981 | 2981 |
| SO2 | ppmvw | 209 | 209 | 209 | 42 | 42 | 42 | 42 |
| COS | ppmvw | 274 | 274 | 274 | 1 | 1 | 1 | 1 |
| CS2 | ppmvw | 668 | 668 | 668 | 7 | 7 | 7 | 7 |
| N2 | vol. % | 34.21% | 34.21% | 34.21% | 34.22% | 34.22% | 34.22% | 34.22% |
| O2 | vol. % | 0.24% | 0.24% | 0.24% | 0.24% | 0.24% | 0.24% | 0.24% |
| CH4 | vol. % | 0.38% | 0.38% | 0.38% | 0.38% | 0.38% | 0.38% | 0.38% |
| C2H2 | vol. % | 0.13% | 0.13% | 0.13% | 0.13% | 0.13% | 0.13% | 0.13% |
| H2 | vol. % | 14.93% | 14.93% | 14.93% | 14.88% | 23.84% | 23.84% | 24.26% |
| CO2 | vol. % | 1.51% | 1.51% | 1.51% | 1.60% | 10.56% | 10.56% | 10.98% |
| CO | vol. % | 9.43% | 9.43% | 9.43% | 9.43% | 0.47% | 0.47% | 0.05% |
| H2O | vol. % | 38.93% | 38.93% | 38.93% | 38.81% | 29.85% | 29.85% | 29.43% |

TABLE 1B

| | | Stream Number | | | | | | |
|---|---|---|---|---|---|---|---|---|
| | Unit | 08 | 09 | 10 | 11 | 12 | 13 | 14 |
| Description | | WHB1 | WHB1 | WHB1 | WHB2 | WHB2 | WHB2 | TG after |
| | | BFW | BFW | Steam | BFW | BFW | Steam | Amine |
| | | | | | | | | reboiler |
| Flow | kmol/h | | | | | | | 5,532 |
| Flow | Nm3/h | | | | | | | 123,979 |
| Flow | ac m3/h | | | | | | | 163,456 |
| Flow | kg/h | 10,754 | 10,754 | 10,341 | 7,719 | 7,719 | 7,416 | 113,412 |
| Temperature | deg. C. | 25 | 25 | 184 | 25 | 25 | 184.2149 | 54.6 |
| pressure | bara | 1.01 | 13.01 | 11.01 | 1.01 | 13.01 | 11.01 | 1.43 |
| Composition | | | | | | | | |
| H2S | ppmvw | | | | | | | 2981 |
| SO2 | ppmvw | | | | | | | 42 |
| COS | ppmvw | | | | | | | 1 |
| CS2 | ppmvw | | | | | | | 7 |
| N2 | vol. % | | | | | | | 34.22% |
| O2 | vol. % | | | | | | | 0.24% |
| CH4 | vol. % | | | | | | | 0.38% |
| C2H2 | vol. % | | | | | | | 0.13% |
| H2 | vol. % | | | | | | | 24.26% |
| CO2 | vol. % | | | | | | | 10.98% |
| CO | vol. % | | | | | | | 0.05% |
| H2O | vol. % | 100.00% | 100.00% | 100.00% | 100.00% | 100.00% | 100.00% | 29.43% |

TABLE 1C

| | | Stream Number | | | | | | | |
|---|---|---|---|---|---|---|---|---|---|
| | Unit | 15 | 16 | 17 | 18 | 19 | 20 | 21 | 22 |
| Description | | Cold TG | TG at | Water | clean | Sour | Air to | CO2 to | Elemental |
| | | | Amine | to | TG | gas to | H2S | liquification | S product |
| | | | scrubber | recycle | | H2S | oxidizer | | |
| | | | inlet | | | Oxidizer | | | |
| Flow | kmol/h | 5,532 | 4,182 | | 3,561 | 621 | 117 | 621 | |
| Flow | Nm3/h | 123,979 | 93,735 | | 79,806 | 13,929 | 2,622 | 13,929 | |
| Flow | ac | 153,357 | 115,946 | | 98,717 | 17,229 | 5,686 | 15,394 | |
| | m3/h | | | | | | | | |
| Flow | kg/h | 113,412 | 89,029 | 24,383 | 61,839 | 27,190 | 261 | 26,928 | 871 |
| Temperature | deg. C. | 40 | 40 | 40 | 40 | 40 | 25 | 27 | 27 |
| pressure | bara | 1.40 | 1.40 | 1.40 | 1.10 | 1.40 | 2.01 | 1.40 | |
| Composition | | | | | | | | | |
| H2S | ppmvw | 2981 | 3895 | 149 | 0 | 26210 | 0 | 0 | |
| SO2 | ppmvw | 42 | 52 | 9 | 0 | 0 | 0 | 0 | |
| COS | ppmvw | 1 | 2 | 0 | 2 | 0 | 0 | 0 | |
| CS2 | ppmvw | 7 | 6 | 8 | 7 | 0 | 0 | 0 | |
| N2 | vol. % | 34.22% | 45.25% | 0.04% | 53.14% | 0.00% | 0.00% | 0.00% | |
| O2 | vol. % | 0.24% | 0.32% | 0.00% | 0.37% | 0.00% | 100.00% | 0.00% | |
| CH4 | vol. % | 0.38% | 0.50% | 0.00% | 0.59% | 0.00% | 0.00% | 0.00% | |
| C2H2 | vol. % | 0.13% | 0.17% | 0.00% | 0.20% | 0.00% | 0.00% | 0.00% | |
| H2 | vol. % | 24.26% | 32.09% | 0.00% | 37.69% | 0.00% | 0.00% | 0.00% | |
| CO2 | vol. % | 10.98% | 14.47% | 0.18% | 0.00% | 97.38% | 0.00% | 97.38% | |
| CO | vol. % | 0.05% | 0.07% | 0.00% | 0.08% | 0.00% | 0.00% | 0.00% | |
| H2O | vol. % | 29.43% | 6.74% | 99.76% | 7.92% | 0.00% | 0.00% | 2.62% | 40 wt % |
| S | wt. % | | | | | | | | 60 wt % |

As shown in the Table, the sulfur amount in the starting gas stream is almost completely removed with only 2 ppm COS and 7 ppm of CS2 in the cleaned tailgas 18. The process, in the simulation, produced 871 kg/h of marketable elemental sulfur containing around 40 wt % of water The purity of the recovered components would also meet desired disposal specifications for commercial sale for use by third parties.

More specifically, in this model process, a hypothetical tail gas, that is representative for commonly used carbon black production process, containing 1218 ppmvw of hydrogen sulfide, 209 ppmvw of SO₂, 274 ppmvw of COS, 668 ppmvw of CS₂, 34 vol % nitrogen, 15 wt % hydrogen, 1.5 vol % carbon dioxide, and 39% water, with other components listed in Table 1A, was processed to generate a cleaned tail gas containing 53 vol % nitrogen, 37 vol % hydrogen, 7.9 vol % water, no carbon dioxide, and other components as listed in Table 1C. A 97% carbon dioxide stream (balance water) was generated for further processing, such as compression, dewatering, liquification etc. for sequestration or use in other beneficial processes.

The present invention can include any combination of these various features or embodiments above and/or below as set forth in any sentences and/or paragraphs herein. Any combination of disclosed features herein is considered part of the present invention and no limitation is intended with respect to combinable features.

The applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated.

1. A process to clean a gas stream comprising tail gas generated during carbon black production, said process comprising
compressing the gas stream to obtain a compressed gas stream;
conducting at least one hydrolysis reaction to obtain at least H₂S, conducting at least one hydrogenation reaction to convert at least one of SO₂ and SO₃ to H₂S, and conducting at least one oxygen conversion reaction to remove O₂ from the compressed gas stream, thereby obtaining an O₂-poor gas stream;
conducting at least one water gas shift reaction on the O₂-poor gas stream to obtain at least CO₂ and thereby obtain a conditioned syngas stream;
removing at least a portion of said H₂S and CO₂ from said conditioned syngas stream to obtain a sour gas stream containing said H₂S and CO₂ and obtain a treated gas stream having fuel value;
converting at least a portion of the H₂S in said sour gas stream to elemental sulfur and removing said elemental sulfur and obtain a sulfur removal off gas; and
capturing at least a portion of said CO₂ in said sulfur removal off gas, wherein the at least one oxygen conversion reaction either comprises a further hydrogenation reaction to convert O₂ to H₂O or a reaction to convert carbon monoxide to carbon dioxide or both.

2. The process of claim 1, wherein prior to conducting said at least one hydrolysis reaction, said at least one hydrogenation reaction, and said at least one water gas shift reaction, removing at least a portion of any particulates and/or any catalyst poisons from said gas stream or said compressed gas stream.

3. The process of claim 1, wherein the at least one water gas shift reaction occurs after said at least hydrolysis reaction and after said at least hydrogenation reaction.

4. (canceled)

5. (canceled)

6. The process of claim 1, wherein said gas stream further comprises gaseous fuel from non-carbon black production sources.

7. (canceled)

8. The process of claim 1, wherein at least 80 vol % of the gas stream is CO, CO₂, N₂, O₂, H₂, hydrocarbons, and water, and also includes trace amounts of sulfur species and nitrogen species, and optionally one or more of HCl, and PH₃ and particulates.

9. (canceled)

10. (canceled)

11. The process of claim 1, where said at least one hydrolysis reaction is achieved by utilizing at least one hydrolysis catalyst.

12. The process of claim 1, where said at least one hydrogenation reaction is achieved by utilizing at least one hydrogenation catalyst.

13. The process of claim 1, wherein said at least one gas shift reaction is achieved by utilizing at least one sulfur-resistant catalyst that converts CO and H₂O to CO₂ and H₂.

14. (canceled)

15. (canceled)

16. The process of claim 1, wherein said removing at least a portion of said H₂S and CO₂ from said conditioned syngas stream is achieved by utilizing an amine scrubber, sour gas absorption with non-amine solvent(s), or pressure swing adsorption.

17. The process of claim 1, wherein said converting of at least a portion of the H₂S in said sour gas stream to elemental sulfur is achieved by utilizing a liquid phase catalytic oxidation process or gas phase combustion process.

18. The process of claim 17, wherein said gas phase combustion process utilizes a Claus process that converts H₂S and SO₂ to H₂O and S₂.

19. (canceled)

20. (canceled)

21. The process of claim 1, said process further comprising conducting at least one reduction reaction to the compressed gas stream or the conditioned syngas stream to convert at least a portion of the nitrogen containing species to N₂.

22. The process of claim 1, wherein said at least one hydrolysis reaction converts sulfur species in the compressed gas stream to H₂S, and said sulfur species include CS₂, COS, and organic sulfur.

23. The process of claim 1, wherein said at least one hydrolysis reaction further converts HCN to NH₃.

24. The process of claim 1, wherein said at least one hydrogenation reaction converts SO₂, and SO₃ to H₂S and converts O₂ to either H₂O or CO₂ or both.

25. A facility to clean a gas stream comprising tail gas generated during carbon black production, said facility comprising
at least one compressor for compressing the gas stream so as to obtain a compressed gas stream;
a catalytic converter unit comprising one or more fixed bed reactors that are configured for conducting at least one hydrolysis reaction to obtain at least H₂S and conducting at least one hydrogenation reaction to obtain at least H₂S, and conducting at least one water gas shift reaction on the compressed gas stream to obtain CO₂ and obtain a conditioned syngas stream;
a sour gas capturing unit for removing at least a portion of said H₂S and CO₂ from said conditioned syngas stream to obtain a sour gas stream containing said H₂S and CO₂ and obtain a treated gas stream having fuel value;
a sulfur conversion unit for converting at least a portion of the H₂S in said sour gas stream to elemental sulfur and removing said elemental sulfur and obtain a sulfur removal off gas; and
a CO₂ capturing unit for capturing at least a portion of said CO₂ in said sulfur removal off gas.

26. (canceled)

27. The facility of claim 24, wherein said one or more fixed bed reactors comprise at least one hydrogenation catalyst, at least one hydrolysis catalyst, and at least one sulfur-resistant catalyst.

28. (canceled)

29. (canceled)

30. The facility of claim 24, wherein said sour gas capturing unit comprises an amine scrubber, a sour gas absorption unit with non-amine solvent(s), or a pressure swing adsorption unit.

31. (canceled)
